(19) United States
(12) Patent Application Publication
(10) Pub. No.: US 2015/0208810 A1
(43) Pub. Date: Jul. 30, 2015

(54) FOLDABLE CHAIR HAVING PORTABLE TELEPHONE HOLDER

(71) Applicant: ABLE POINT CO., LTD., SEOUL (KR)

(72) Inventor: Kyung Ku KIM, Gimpo-si (KR)

(73) Assignee: ABLE POINT CO., LTD., Seoul (KR)

(21) Appl. No.: 14/165,197

(22) Filed: Jan. 27, 2014

(51) Int. Cl. A47C 7/62; H04M 1/11; A47C 4/00

(52) U.S. Cl. CPC A47C 7/62; A47C 4/00; H04M 1/11

(57) ABSTRACT

Disclosed is a portable telephone holder. The portable telephone holder includes a holder body having sidewalls on four side surfaces thereof and longitudinally perforated to hold a portable telephone; and front and rear panels installed on front and rear surfaces of the holder body, respectively. A maximum height of the front panel is lower than a maximum height of the rear panel and is higher than a height of an upper end of the holder body. Position limiting panels are installed to left and right sides of the holder body, respectively, to limit a position of a portable telephone, which is transversely placed at the upper end of the holder body, in left and right directions.

### BACKGROUND OF THE INVENTION

1. Field of the Invention

The present invention relates to a foldable chair having a portable telephone holder. In more particular, the present invention relates to a foldable chair having a portable telephone holder installed on an armrest of the foldable chair.

2. Description of the Related Art

Recently, as network and electronic techniques make great stride, various electric products have been continuously launched. Among them, portable telephones having the communication function have been continuously replaced with new products. In addition, the performance of a portable telephone has been greatly advanced and the screen size has been gradually enlarged. The portable telephones have been developed from early simple communication technique to network and multimedia technique widely used today, so that the portable telephones have brought about great convenience in human life. As electronic techniques have been greatly developed, a portable telephone holder has been released. However, most of the portable telephone holders according to the related art simply have the function of holding the portable telephone, so that the portable telephone holders cannot provide optimal sets in cooperation with smart phones having advanced network and multimedia techniques.

A foldable chair, which is convenient and foldable, can be simply carried and can save space, so that the foldable chair has been widely used indoors and outdoors. The foldable chair according to the related art is generally focused on the function of a chair itself, so that it is inconvenient to install the portable telephone holder to the foldable chair. In addition, the foldable chair has no structure for installing the portable telephone holder.

### SUMMARY OF THE INVENTION

The present invention has been made to solve the above problems occurring in the related art, and an object of the present invention is to provide a foldable chair capable of receiving a portable telephone in longitudinal and horizontal directions to bring about great convenience in human life.

In order to accomplish the above object, there is provided a portable telephone holder including a holder body having sidewalls on four side surfaces thereof and longitudinally perforated to hold a portable telephone; and front and rear panels installed on front and rear surfaces of the holder body, respectively, wherein a maximum height of the front panel is lower than a maximum height of the rear panel and is higher than a height of an upper end of the holder body; and position limiting panels are installed to left and right sides of the holder body, respectively, to limit a position of a portable telephone, which is transversely placed at the upper end of the holder body, in left and right directions.

The front panel extends out of the holder body in left and right side directions, and front ends of the position limiting panels are connected integrally with left and right ends of the front panel, respectively.

The rear panel is inclined rearward at an inside of the holder body, and each of the position limiting panels has an arc structure.

The portable telephone holder further includes a first flange formed on four surfaces of a lower end of the holder body.

The portable telephone holder further includes a second flange formed on the four surfaces of the upper end of the holder body.

The portable telephone holder further includes a lower holder having sidewalls at the four surfaces of the portable telephone holder and longitudinally perforated, wherein a second flange is provided on the four surfaces of the upper end of the holder body, and the holder body is detachably inserted into the lower holder, and the second flange makes contact with an upper end of the lower holder so that a position of the second flange is limited.

The portable telephone holder further includes a third flange formed on four surfaces of the upper end of the lower holder.

Further, according to the present invention, there is provided a foldable chair including a portable telephone holder; a foldable chair body including an armrest; and a receiving space formed in the armrest and having an opening directed upward to receive the holder body of the portable telephone holder.

In addition, a second flange is formed on four surfaces of an upper end of the holder body, the holder body of the portable telephone is received in the receiving space, and the second flange makes contact with an outer periphery of the opening of the receiving space so that a position of the second flange is limited.

The portable telephone holder includes the lower holder having sidewalls at the four surfaces of the portable telephone holder and longitudinally perforated and the third flange formed on four surfaces of the upper end of the lower holder. The lower holder is received in the receiving space of the chair body and the third flange makes contact with an outer periphery of the opening of the receiving space so that the position of the third flange is limited. The holder body is inserted into the lower holder to be detachable and the second flange 12 makes contact with the third flange 51 on the upper end of the lower holder 5 so that the position of the second flange is limited.

The present invention has the following advantages.

First, the portable telephone holder according to the present invention including the holder body, the front and rear panels installed on the holder body, and the left and right position-limiting panel can implement the function of receiving the portable telephone and allow the portable telephone to be transversely placed therein, so that the portable telephone holder can be useful as the exclusive holder when watching moving pictures displayed on the smart phone.

Second, the holder body according to the present invention is installed in the armrest of the foldable chair together with the lower holder, so that the holder body may be used as the portable telephone holder.

Third, the foldable chair according to the present invention includes the portable telephone holder so that the foldable chair further has the function of the portable telephone holder. Thus, a user can take a rest in the foldable chair, and at the same time, the user can place the portable telephone in the portable telephone holder to watch a moving picture through the portable telephone, so that the user can take a rest with pleasant feeling.

The present invention will be described in detail with reference to accompanying drawings in combination with embodiments, but the foldable chair in which the portable telephone holder according to the present invention is not limited thereto.

### BRIEF DESCRIPTION OF THE DRAWINGS

FIG. 1 is an exploded perspective view showing a portable telephone holder according to an embodiment of the present invention.

FIG. 2 is a perspective view showing a portable telephone holder when seen from a rear surface of a holder body according to an embodiment of the present invention.

FIG. 3 is a perspective view showing three-dimensional structure of a portable telephone according to an embodiment of the present invention.

FIG. 4 is a perspective view showing an application state of the portable telephone holder according to an embodiment of the present invention.

FIG. 5 is a perspective view showing another application state of the portable telephone holder according to an embodiment of the present invention

FIG. 6 is an exploded perspective view showing a foldable chair according to a first embodiment of the present invention.

FIG. 7 is a perspective view showing three-dimensional structure of the foldable chair of FIG. 6.

FIG. 8 is a perspective view showing an application state of the foldable chair of FIG. 6

FIG. 9 is an exploded perspective view showing a foldable chair according to a second embodiment of the present invention.

FIG. 10 is a perspective view showing an installation state of the portable telephone holder.

FIG. 11 is a perspective view showing three-dimensional structure of the portable telephone holder.

### DETAILED DESCRIPTION OF THE INVENTION

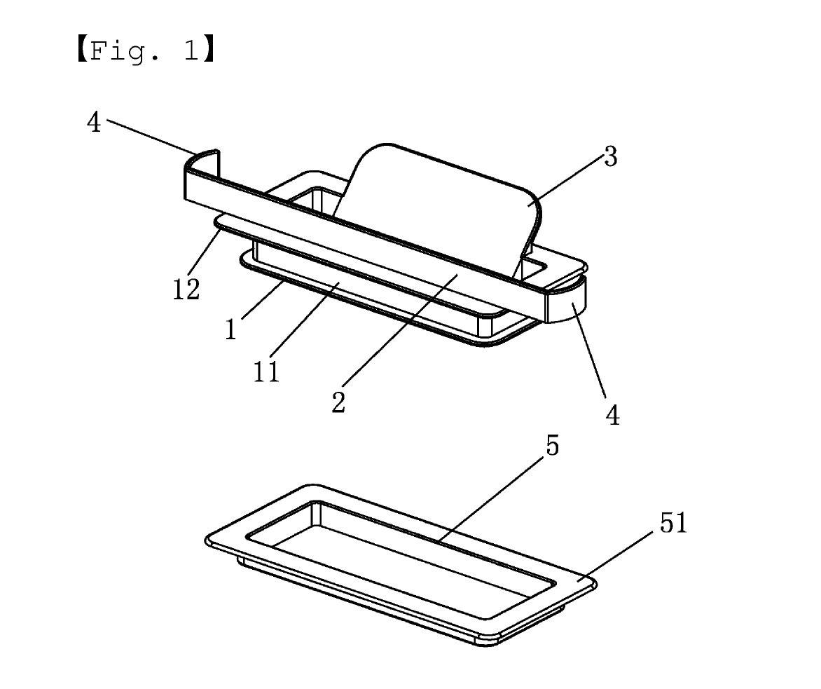

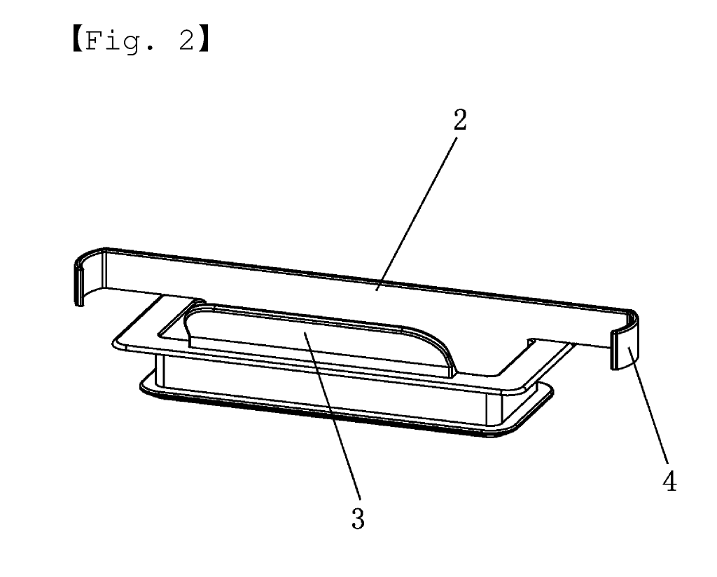

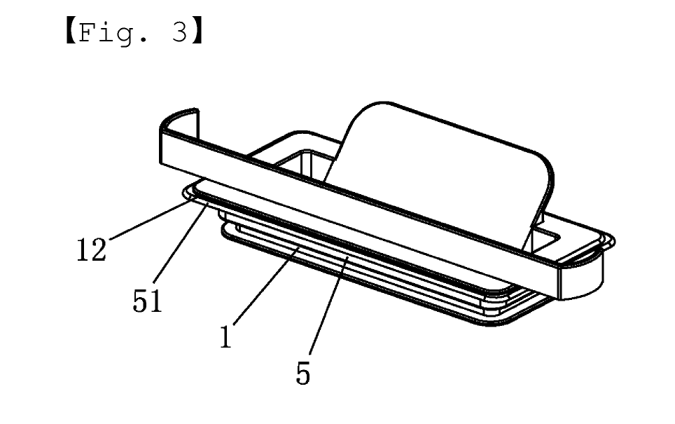

Referring to FIGS. 1 to 3, a portable telephone holder according to an embodiment of the present invention includes a holder body 1 which has sidewalls (side wall [symbol] sidewall [symbol] ) formed on four surfaces thereof and is longitudinally perforated to form a rectangular-shaped frame structure, so that a portable telephone is longitudinally held therein, and front and rear panels 2 and 3 installed on front and rear surfaces of the holder body 1, respectively. The holder body 1, and the front and rear panels 2 and 3 are integrally formed of synthetic resin through a molding scheme. The front panel 2 has a long panel structure formed on a main portion which is operated as a stopper and is fixed to an upper end of a front surface of the holder body 1. The maximum height of the front panel 2 is higher than that of the upper end of the holder body 1 and the width of the front panel 2 is wider than that of the holder body 1. The left and right ends extend out of the holder body 1, respectively. The rear panel 3 is inclined rearward at an inside of the holder body 1. The rear panel 3 is molded integrally with holder body 1 and is fixed to the rear surface of the holder body 1. The width of the rear panel 3 is narrower than the inner width of the holder body 1. The maximum height of the front panel 2 is lower than the maximum height of the rear panel 3. Position limiting panels 4 are installed to the left and right side of the holder body, respectively. In detail, the front ends of the position limiting panels 4 are connected integrally with the left and right ends of the front panel 2. The position limiting panels 4 are installed to the left and right side of the holder body 1, respectively to limit a position of a portable telephone, which is placed at the upper end of the holder body 1 and leans against the rear panel 3, in left and right directions.

Preferably, the first flange 11 is formed on four surfaces of the lower end of the holder body 1. When the holder body 1 is placed on a table such as an office desk, the first flange 11 has a relatively large area making contact with the table surface, so that the first flange 11 solidly supports the hold body 1 to prevent the hold body 1 from falling down in one side direction.

Preferably, the second flange 12 is installed on four surfaces of the upper end of the holder body 1. The area the upper end of the second flange 12 is larger than that of the lower end of the first flange 11.

Preferably, the portable telephone holder according to an embodiment of the present invention includes sidewalls on the four surfaces thereof and a lower holder 5 longitudinally perforated. A third flange is installed on four surfaces of the upper end of the lower holder 5. The first flange 11 of the holder body 1 is inserted into the lower holder 5 so that the second flange 12 makes contact with the third flange 51 on the upper end of the lower holder 5, limiting the movement of the second flange 12.

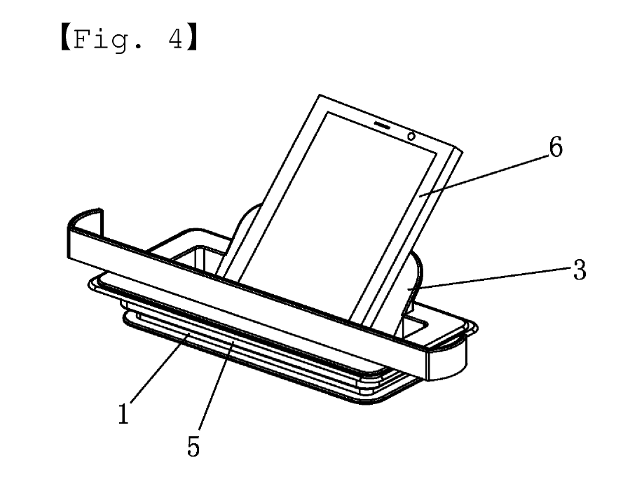

The present invention may be applied in two states. As shown in FIG. 4, in one application state of the present invention, the holder body 1 is integrally molded with the rear panel 3 so that the portable telephone 6 may be longitudinally placed in the portable telephone holder. In this case, the left and right sides of the portable telephone 6 is position-limited by the left and right sidewalls of the holder body 1. The front surface of the portable telephone 6 is position-limited by the sidewall of the front surface of the holder body 1 and the rear surface of the portable telephone 6 is supported by the rear panel 3.

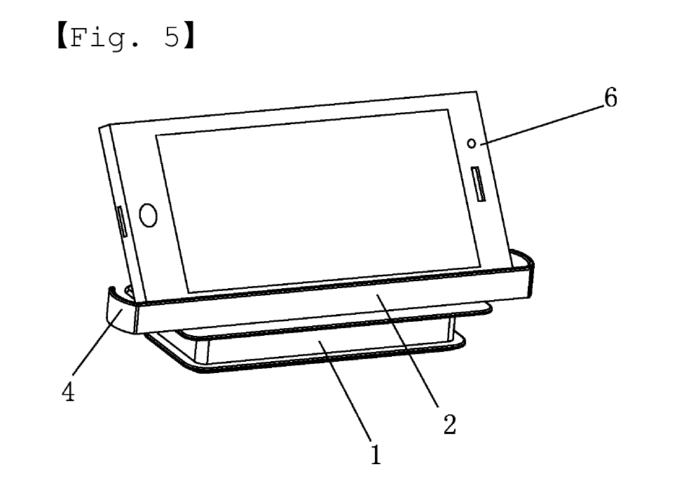

In the other application state, as shown in FIG. 5, the holder body 1 cooperates with the front and rear panels 2 and 3 and two position limiting panels 4 such that the portable telephone is transversely placed. In this case, the portable telephone 6 leans against the left and right upper ends of the holder body 1 and the front surface of the portable telephone 6 is position-limited by the front panel 2. The rear surface of the portable telephone 6 is supported by the rear panel 3 and the left and right sides of the portable telephone 6 are position-limited by the position limiting panels 4, so that the portable telephone can be prevented from slipping down.

### Embodiment 1

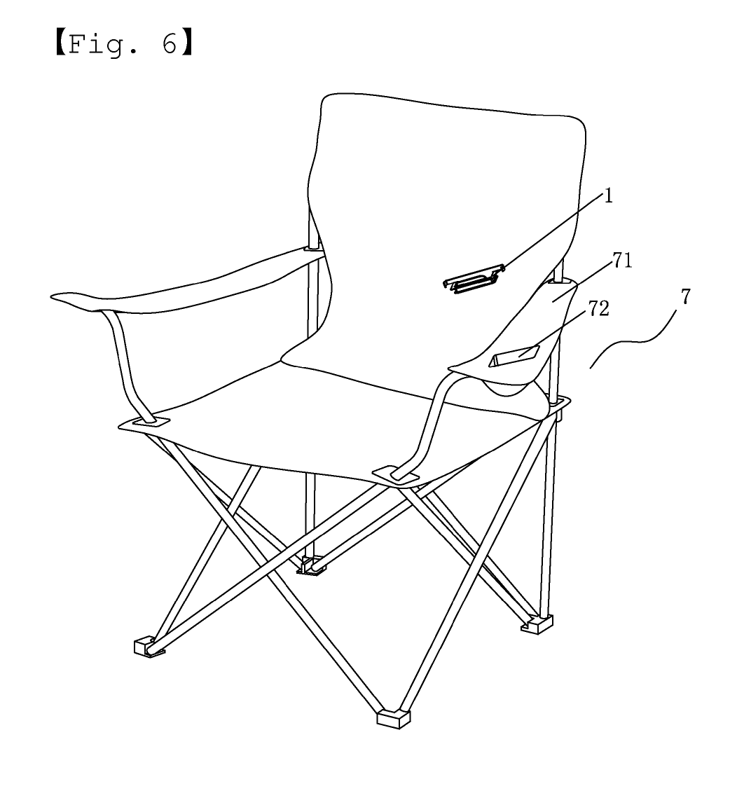

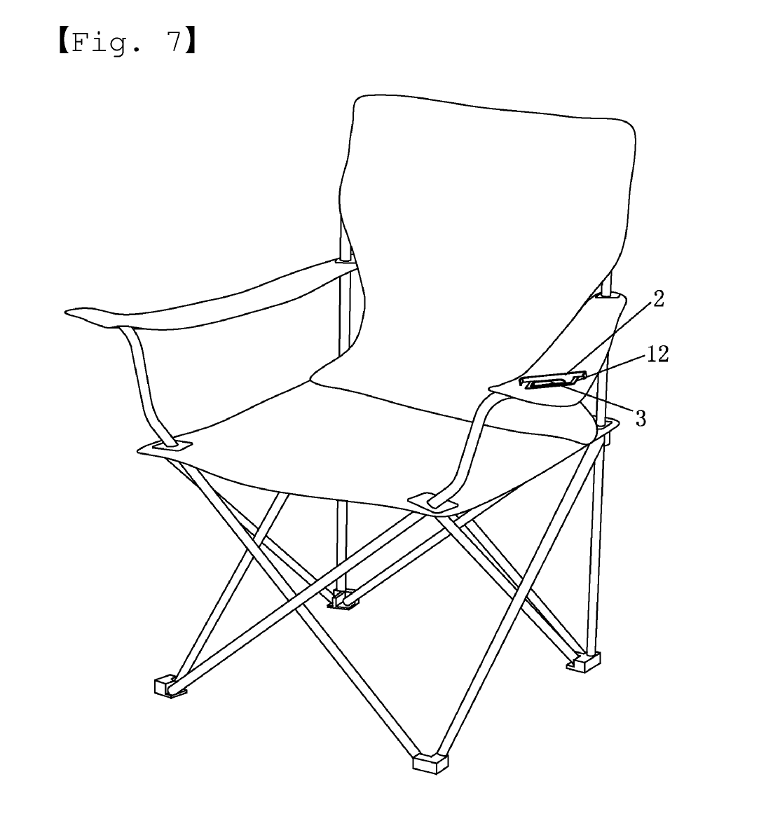

As shown in FIGS. 6 to 8, a foldable chair, in which a portable telephone holder according to an embodiment of the present invention is installed, includes a chair body 7 having an armrest and a portable telephone holder. As described above, the portable telephone holder includes the holder body 1, the front and rear panels 2 and 3, two position limiting panel 4, the first flange 11 on the four surface of the lower end of the holder body 1, and the second flange on the four surfaces of the upper end of the holder body 1. A receiving space is provided at the armrest of the chair body 1 with an opening directed upward. The holder body 1 of the portable telephone holder is inserted into the receiving space. In detail, the chair body 7 includes a chair back, the armrest, a seat and legs. The receiving space is formed in a pocket 72 having the opening placed at the front end of the armrest of the chair body 7 and directed upward. The holder body 1 of the portable telephone is inserted into the pocket 72 and the second flange 12 makes contact with an outer periphery of the pocket 72, so that the position of the second flange 12 is limited.

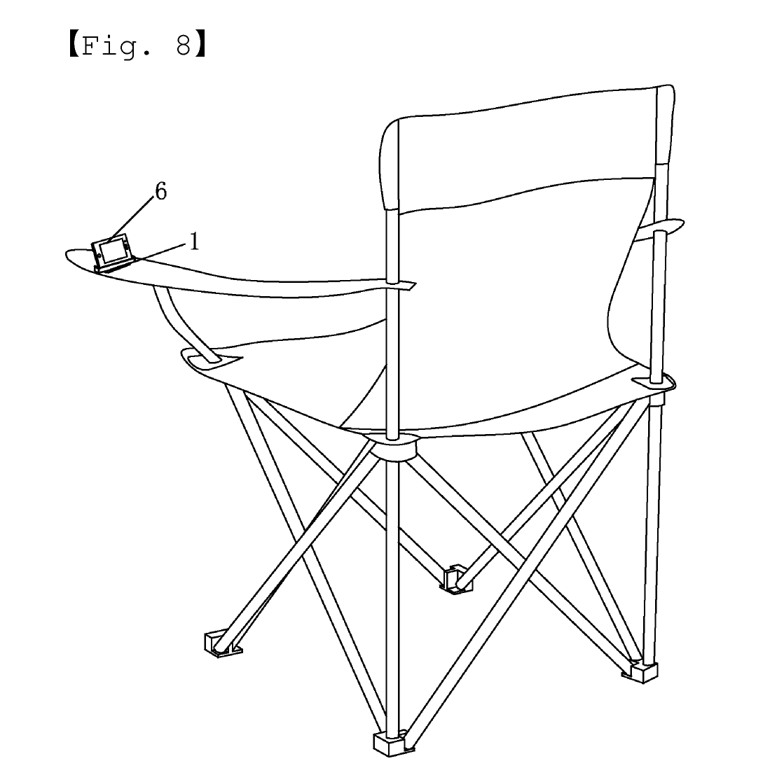

Preferably, the pocket 72 is installed in a diagonal direction about the longitudinal direction of the armrest so that a user may see the front of the portable telephone 6 when the user sitting in the foldable chair turns his head toward the armrest. In detail, the pocket 72 has a rectangular shape. The side of the pocket 72 having a long length is installed diagonally to the longitudinal direction of the armrest 71 at a predetermined angle. The predetermined angel preferably includes 30 degrees about the axis in the width direction perpendicular to the longitudinal direction of the armrest 71 toward the user sitting in the chair. As described above, the portable telephone holder is installed in the pocket 72 of the chair body 7, as shown in FIG. 8, so that a suitable angle to watch a moving picture can be formed when the portable telephone is transversely placed on the portable telephone holder.

According to the foldable chair of the present invention, the holder body 1 of the portable telephone holder is inserted into the pocket 72 of the chair body 7, so that the second flange 12 of the holder body 1 is limited by the outer periphery of the pocket 72. Like the above, the portable telephone holder of the foldable chair may be used in two using states. In one using state, the portable telephone may be longitudinally placed. In this case, as shown in FIG. 8, the inner surface of the pocket supports the portable telephone. In the other using state, the portable telephone is transversely placed in the pocket 72.

According to the foldable chair of the present invention, after installing the portable telephone holder, when a user has a rest in the foldable chair and places the portable telephone in the portable telephone holder to watch a moving picture through the portable telephone, the portable telephone holder is usable as the exclusive holder, so that the user can have a rest and in addition, can feel pleasant.

### Embodiment 2

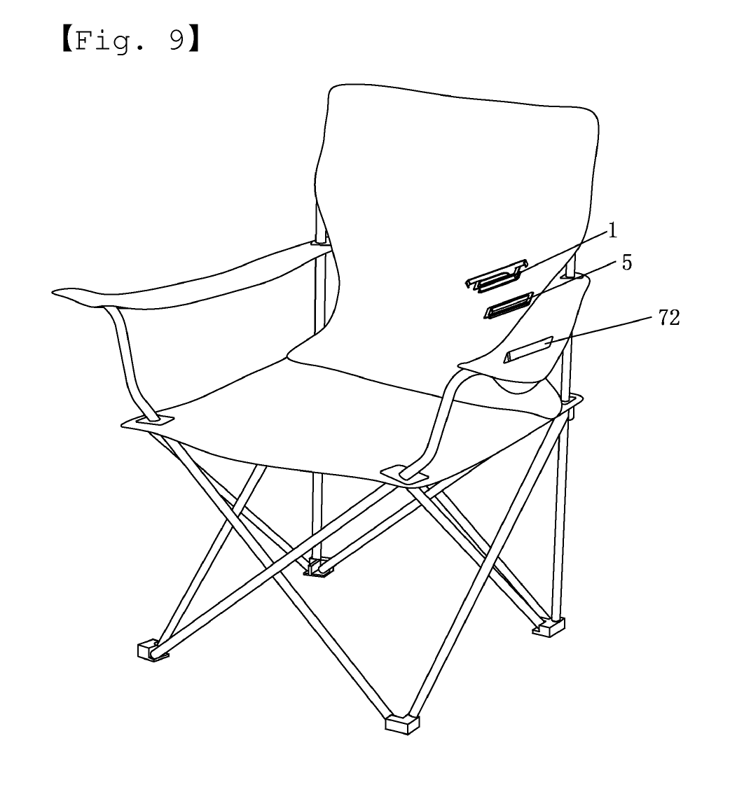

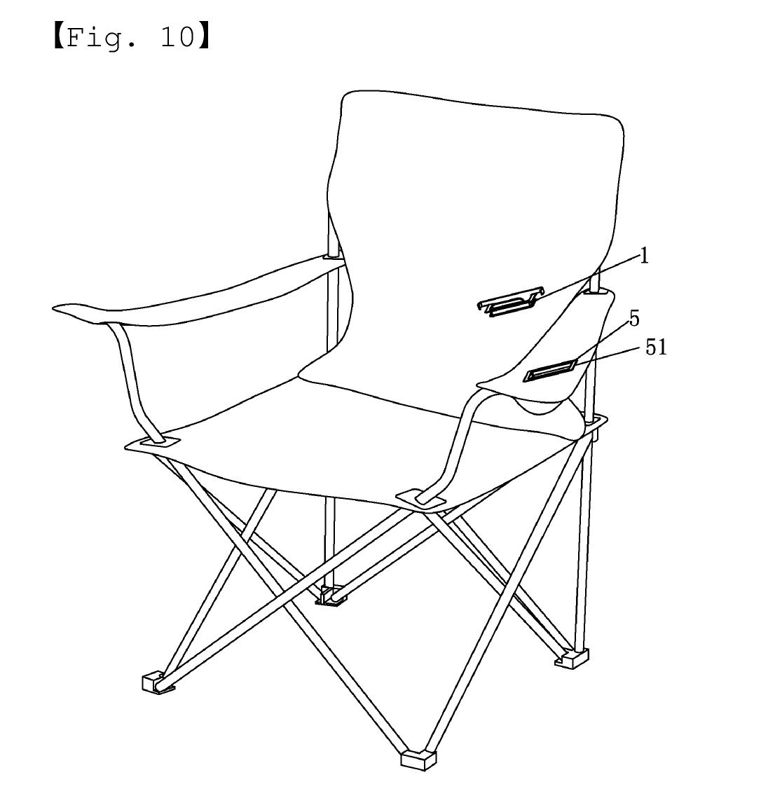

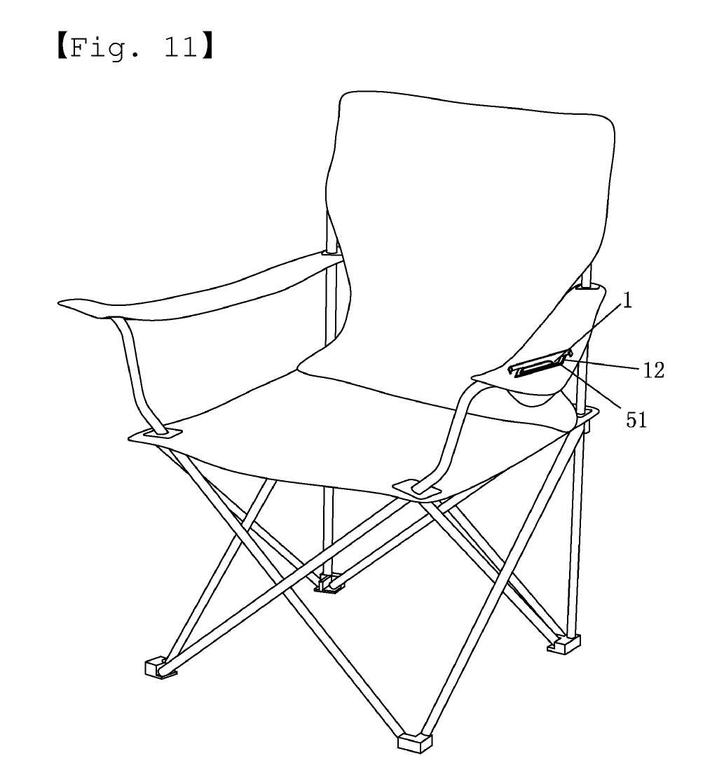

Unlike embodiment 1, the foldable chair according to the present invention, as shown in FIGS. 9 to 11, includes the lower holder 5. Similarly, a third flange 51 is formed on the four surface of the upper end of the lower holder 5.

In the foldable chair of the present invention, the lower folder 5 is inserted into the pocket 72 of the chair body 7 so that the third flange 51 makes contact with the periphery of the pocket 72 to be limited. The holder body 1 is inserted into the lower holder 5 so that the second flange 12 of the holder body 1 makes contact with the upper end of the lower holder 5 to limit the place. The reason that the lower holder 5 is installed is because the pocket 72 of the chair body 7 is made of cotton so that the shape of the pocket 72 is easily changed. Since the rectangular shape of the pocket 72 is maintained when the lower holder 5 is first inserted, the portable telephone holder is more stable and solid after the holder body 1 is inserted into the pocket 72 of the chair body.

Similar to the foldable chair described embodiment 1, the foldable chair according to embodiment 2 allows a portable telephone to be longitudinally or transversely placed in the portable telephone holder after the portable telephone holder is installed in the foldable chair.

The embodiments are proposed for the purpose of describing in detail the portable telephone holder and the foldable chair according to the present invention, but the present invention is not limited thereto. Although a preferred embodiment of the present invention has been described for illustrative purposes, those skilled in the art will appreciate that various modifications, additions and substitutions are possible, without departing from the subject matter of the present invention.

What is claimed is:

1. A portable telephone holder comprising:
a holder body having sidewalls on four side surfaces thereof and longitudinally perforated to hold a portable telephone; and
front and rear panels installed on front and rear surfaces of the holder body, respectively,
wherein a maximum height of the front panel is lower than a maximum height of the rear panel and is higher than a height of an upper end of the holder body; and
position limiting panels are installed to left and right sides of the holder body, respectively, to limit a position of a portable telephone, which is transversely placed at the upper end of the holder body, in left and right directions.

2. The portable telephone holder of claim 1, wherein the front panel extends out of the holder body in left and right side directions, and
front ends of the position limiting panels are connected integrally with left and right ends of the front panel, respectively.

3. The portable telephone holder of claim 1, wherein the rear panel is inclined rearward at an inside of the holder body, and each of the position limiting panels has an arc structure.

4. The portable telephone holder of claim 1, further comprising a first flange formed on four surfaces of a lower end of the holder body.

5. The portable telephone holder of claim 1, further comprising a second flange formed on the four surfaces of the upper end of the holder body.

6. The portable telephone holder of claim 1, further comprising a lower holder having sidewalls at the four surfaces of the portable telephone holder and longitudinally perforated,
wherein a second flange is provided on the four surfaces of the upper end of the holder body, and the holder body is detachably inserted into the lower holder, and
the second flange makes contact with an upper end of the lower holder so that a position of the second flange is limited.

7. The portable telephone holder of claim 6, further comprising a third flange formed on four surfaces of the upper end of the lower holder.

8. A foldable chair including a portable telephone holder according to claim 1, the foldable chair comprising:
a foldable chair body including an armrest; and
a receiving space formed in the armrest and having an opening directed upward to receive the holder body of the portable telephone holder.

9. The foldable chair of claim 8, wherein a second flange is formed on four surfaces of an upper end of the holder body, the holder body of the portable telephone is received in the receiving space, and the second flange makes contact with an outer periphery of the opening of the receiving space so that a position of the second flange is limited.
